(19) United States
(12) Patent Application Publication
(10) Pub. No.: US 2008/0000164 A1
(43) Pub. Date: Jan. 3, 2008

(54) Snubber Mechanism for Window Assembly

(75) Inventors: Gary M. Erickson, Lena, IL (US); William Rogers Smitih, Rockford, IL (US)

Correspondence Address: BANNER & WITCOFF, LTD., TEN SOUTH WACKER DRIVE, SUITE 3000, CHICAGO, IL, 60606, US

(73) Assignee: NEWELL OPERATING COMPANY, Atlanta, GA (US)

(21) Appl. No.: 11/763,126

(22) Filed: Jun. 14, 2007

Related U.S. Application Data
(60) Provisional application No. 60/814,099, filed on Jun. 14, 2006.

(51) Int. Cl. E05B 65/06

(52) U.S. Cl. 49/394

(57) ABSTRACT

A casement window assembly includes a hinged sash window pivotally mounted within a window frame. The casement window assembly has a snubber mechanism. The snubber mechanism has a first member connected to the window frame and a second member attached to the sash window. The snubber members have cooperative structures that cooperatively confront each other in spaced relation to selectively engage each other to prevent undue bowing of the sash window when subjected to high stresses such as from high wind loads.

### CROSS-REFERENCE TO RELATED APPLICATIONS

The present application is a continuation-in-part of and claims the benefit of U.S. Provisional Patent Application No. 60/814,099, which application is incorporated by reference herein and made a part hereof.

### FEDERALLY SPONSORED RESEARCH OR DEVELOPMENT

None.

### TECHNICAL FIELD

The invention relates to a window assembly, and more specifically, to a snubber mechanism for a casement window assembly.

### BACKGROUND OF THE INVENTION

A casement window assembly is one form of a window assembly and is known in the art. Casement window assemblies typically have a sash window pivotally mounted in a window frame by hinge assemblies. While casement window assemblies of the prior art provide a number of advantageous features, they nevertheless have certain limitations. For example, casement window assemblies can be subjected to very high winds during storms subjecting the assemblies to high stresses. This can cause bowing of the sash window and over-rotation of the sash window with respect to the window frame. This can permanently damage the casement window assembly requiring complete replacement.

The present invention is provided to solve problems associated with casement window assemblies, and to provide advantages and aspects not provided by prior casement window assemblies. A full discussion of the features and advantages of the present invention is deferred to the following detailed description, which proceeds with reference to the accompanying drawings.

### SUMMARY OF THE INVENTION

The present invention provides a window assembly preferably in the form of a casement window assembly having a snubber mechanism. The casement window assembly has a sash window pivotally supported in a window frame between open positions and a closed position.

According to one aspect of the invention, a snubber mechanism is provided on the casement window assembly. The snubber mechanism has a first member connected to the window frame and a second member attached to the sash window. The snubber members have cooperative structures that cooperatively confront or engage each other to prevent undue bowing of the sash window when subjected to high stresses.

According to another aspect of the invention, the snubber mechanism has a first member adapted to be mounted on the window frame and a second member adapted to be mounted on the sash window. The members have cooperative structures wherein when the sash window is in a closed position with respect to the window frame, the cooperative structures are spaced apart in confronting relation and are adapted to minimize undue bowing of the sash window with respect to the window frame.

According to another aspect of the invention, the first member has a first base adapted to be mounted on the window frame. The first member further has a first leg extending from the first base. The first leg has a first tab extending generally transverse therefrom. The first base, first leg and the first tab cooperatively form a first cavity. The second member has a second base adapted to be mounted on the sash window. The second member further has a second leg extending from the second base. The second leg has a second tab extending generally transverse therefrom. The second base, second leg and the second tab cooperatively form a second cavity.

According to another aspect of the invention, when the sash window is in the closed position, the first tab extends to the second cavity and the second tab extends to the first cavity. The tabs can extend further into the cavities if desired.

According to another aspect of the invention, upon bowing of the sash window frame due to stresses applied to the window assembly, the first tab engages the second leg to prevent undue bowing of the sash window. In addition, the second tab engages the first leg to prevent undue bowing of the sash window.

According to a further aspect of the invention, the first member is identical to the second member.

According to another aspect of the invention, the first member and the second member are concealed when the sash window is in the closed position.

According to another aspect of the invention, the cooperative structures further comprise one of the first member and the second member having a projection and the other of the first member and the second member having a receiver. When the sash window is in a closed position with respect to the window frame, the receiver receives the projection. A plurality of projections and receivers may be included wherein a respective receiver receives a projection.

Other features and advantages of the invention will be apparent from the following specification taken in conjunction with the following drawings.

### BRIEF DESCRIPTION OF THE DRAWINGS

To understand the present invention, it will now be described by way of example, with reference to the accompanying drawings in which:

FIG. 1 is a rear perspective view of a casement window assembly utilized in the present invention;

FIG. 2 is a front view of the casement window assembly shown in FIG. 1;

FIG. 3 is a front perspective of the casement window assembly shown in FIG. 1, the casement window assembly being in an open position, and showing a snubber mechanism of the present invention;

FIG. 4 is a perspective view of a first member of the snubber mechanism shown in FIG. 3;

FIG. 5 is a perspective view of a second member of the snubber mechanism shown in FIG. 3;

FIG. 6 is a schematic partial cross-sectional view showing cooperative structure of the snubber mechanism shown in FIG. 3 when the casement window assembly is in a closed position;

FIG. 7 is a partial cross-sectional view of an alternative embodiment of a snubber mechanism of the present invention;

FIG. 8 is a partial perspective view of a casement window assembly in a closed position showing a portion of another embodiment of a snubber mechanism of the present invention;

FIG. 9 is a partial perspective view of the casement window assembly shown in FIG. 8 having a portion of the sash window removed to expose snubber members of the snubber mechanism;

FIG. 10 is an enlarged partial top view of the casement window assembly of FIG. 8 showing the snubber members;

FIG. 11 is a partial perspective view of the casement window assembly of FIG. 8 shown in an open position;

FIG. 12 is an enlarged partial top view of the casement window assembly shown in FIG. 11 and showing the snubber members;

FIG. 13 is a partial perspective view of a casement window assembly in a closed position showing a portion of another embodiment of a snubber mechanism of the present invention;

FIG. 14 is an enlarged partial top view of the casement window assembly of FIG. 13 showing the snubber members;

FIG. 15 is a partial perspective view of the casement window assembly of FIG. 13 shown in an open position;

FIG. 16 is an enlarged partial top view of the casement window assembly shown in FIG. 15 and showing the snubber members;

FIG. 17 is a partial perspective view of a casement window assembly in a closed position showing a portion of another embodiment of a snubber mechanism of the present invention;

FIG. 18 is an enlarged partial top view of the casement window assembly of FIG. 17 showing the snubber members;

FIG. 19 is a partial perspective view of the casement window assembly of FIG. 17 shown in an open position; and

FIG. 20 is an enlarged partial top view of the casement window assembly shown in FIG. 19 and showing the snubber members.

### DETAILED DESCRIPTION

While this invention is susceptible of embodiments in many different forms, there are shown in the drawings and will herein be described in detail preferred embodiments of the invention with the understanding that the present disclosure is to be considered as an exemplification of the principles of the invention and is not intended to limit the broad aspect of the invention to the embodiments illustrated.

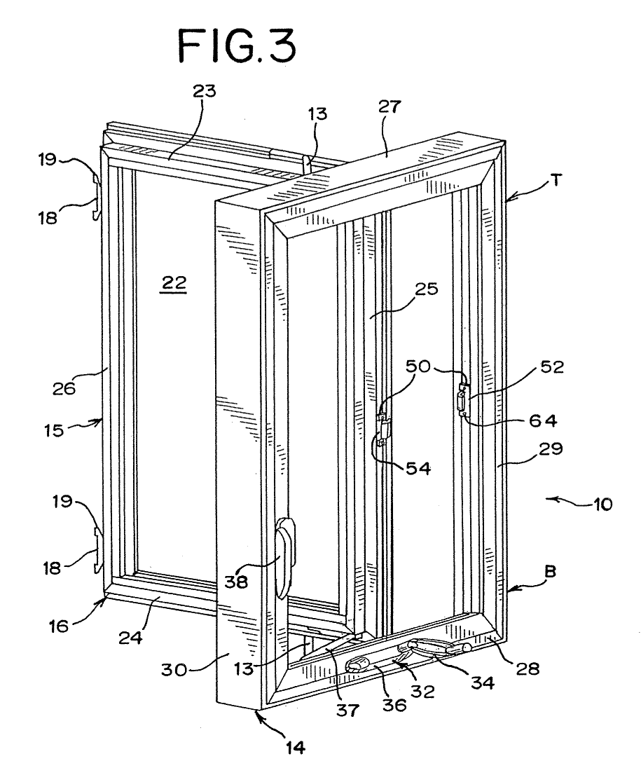

FIGS. 1-3 shows a casement window assembly 10, which includes a jamb frame assembly or window frame 14, and an inner window assembly 16 or sash window 16. The inner window assembly 16 is formed of a sash window frame 15 bordering a window pane 22. The sash window frame 15 is formed by two vertical rails 25,26 and two horizontal rails 23,24. The window frame 14 is formed by two vertical jambs 29,30 and two horizontal jambs 27,28. The sash window 16 and window frame 14 are secured by hinged connections 13, such that the sash window 16 is moveable between an open and closed position relative the window frame 14 by pivotal movement of the sash window 16. FIG. 3 depicts the window assembly 10 with the inner sash window 16 pivoted into the open configuration relative the window frame 14. The inner sash window 16 is moved by an operator assembly 32 that includes an actuator 34, a housing 36 mounted on the bottom jamb 28, and one or more movable operating arms 37 that move back and forth by cranking the actuator 34 to move the inner window assembly 16. The hinged connection 13 includes a hinge assembly that pivotably supports the sash window 16. A locking mechanism 38 is positioned on one of the vertical jambs 30 and the adjacent vertical rail 26 to secure the jamb 30 to the rail 26, locking the window assembly 10 shut. Two keepers 18, each having an extending finger 19, are positioned on the vertical rail 26 adjacent the locking mechanisms 38 for this purpose. It is understood that the casement window assembly 10 can come in various different sizes.

Accordingly, it is understood that a user can use the operator assembly 32 to open and close the casement window assembly 10 as desired. Obviously during severe storms, the casement window assembly 10 is closed and preferably locked. High winds from the storms can subject the casement window assembly 10 to high stresses. This can cause the sash window 16 to bow and over rotate with respect to the window frame 14. A snubber mechanism 50 of the present invention assists in preventing undue bowing of the sash window 16 with respect to the window frame 14 and failure of the casement window assembly.

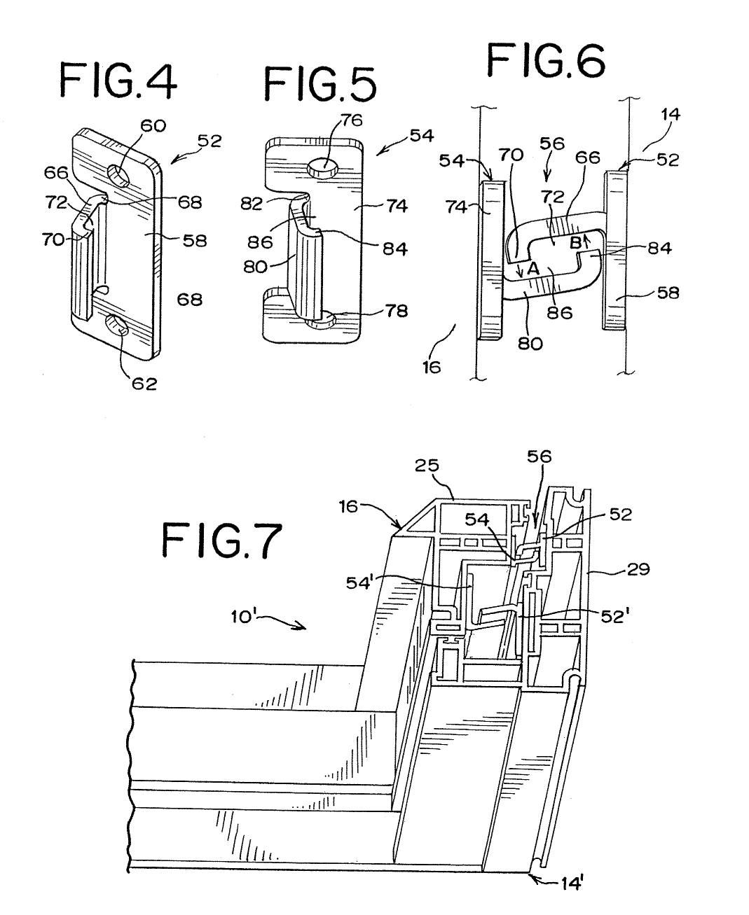

FIGS. 3-6 show an exemplary embodiment of the snubber mechanism 50 of the present invention. As shown in FIG. 3, the snubber mechanism generally includes a first snubber member 52 and a second snubber member 54. The members 52,54 have cooperative structures 56 that assist in preventing undue bowing of the sash window 16 as described in greater detail below. As shown in FIG. 4, the first member 52 has a first base 58 that is designed to be mounted on the window frame 14. The first base 58 is generally a plate-like structure and has a first mounting hole 60 and a second mounting hole 62. The mounting holes 60,62 receive fasteners such as screws 64 (FIG. 3) as described below. Other fasteners could also be used. The first member 52 has a first leg 66 extending from the first base 58. The first leg 66 extends away, and generally transverse to the base 58, but not necessarily at a right angle. In one preferred embodiment, the first leg 66 may extend from the first base 58 at an acute angle. A gap 68 is maintained on each side of the leg 66 where the leg 66 begins to extend from the first base 58. As further shown in FIG. 4, the first member 52 further has a first tab 70 that extends from the first leg 66. The first tab 70 may be considered a part of or a distal end of the first leg 66. The first tab 70 generally extends transverse from the first leg 66. The first tab 70 may extend generally parallel to the base 58. The first base 58, first leg 66, and first tab 70 cooperatively form a first cavity 72. In one preferred embodiment, the components of the first member 52 are integral. The first member 52 is typically made from metal although other suitable materials may be used.

FIG. 5 discloses the second snubber member 54. It is understood that the structures of the first snubber member 52 and the second snubber member 54 are identical. Thus, a single member can serve as both the first snubber member 52 and second snubber member 54 by changing the orientation of the members as can be appreciated from FIGS. 3-6. As further shown in FIG. 5, the second member 54 has a second base 74 that is designed to be mounted on the sash window 16. The second base 74 is generally a plate-like structure and has a first mounting hole 76 and a second mounting hole 78. The mounting holes 76,78 receive fasteners such as screws 64 (FIG. 3) as described above. The second member 54 has a second leg 80 extending from the second base 74. The second leg 80 extends away, and generally transverse to the second base 74, but not necessarily at a right angle. In one preferred embodiment, the second leg 80 may extend from the second base 74 at an acute angle. A gap 82 is maintained on each side of the second leg 80 where the leg 80 begins to extend from the second base 74. As further shown in FIG. 5, the second member 54 further has a second tab 84 that extends from the second leg 80. The second tab 84 may be considered a part of or a distal end of the second leg 80. The second tab 84 generally extends transverse from the second leg 80. The second base 74, second leg 80, and second tab 84 cooperatively form a second cavity 72. In one preferred embodiment, the components of the second member 54 are integral.

As shown in FIG. 3, the snubber mechanism 50 is mounted on the casement window assembly 10. In particular, the first member 52 is mounted on the vertical jamb 29 of the window frame 14. The first member 52 is mounted on an inner face of the vertical jamb 29. In an exemplary embodiment, the first member 52 is mounted proximate a midpoint of the vertical jamb 29. Screws 64 are inserted through the mounting holes 60,62 and into the window frame 14. The second member 54 is mounted on the vertical rail 25 of the sash window 16. The second member 54 is mounted on an outer face of vertical rail 25. Likewise, the second member 54 is mounted proximate a midpoint of the vertical rail 25 so that it may cooperate with the first member 52 as described in greater detail below. It is understood that the snubber mechanism 50 can be mounted at other locations if desired and depending on the orientation of the window assembly 10, may be considered to be mounted on horizontal components of the frame 14 and window 16. Also, the casement window assembly 10 may come in various sizes wherein a plurality of snubber mechanisms 50 can be utilized. For example, a snubber mechanism 50 could be mounted proximate a top T of the casement window assembly 10 and/or proximate a bottom B of the casement window assembly 10. The snubber mechanisms 50 can be spaced along the casement window assembly 10 as desired. The members 52,54 cooperate with one another when the sash window 16 is placed in the closed position relative to the window frame 14, i.e. when the casement window assembly 10 is in the closed position.

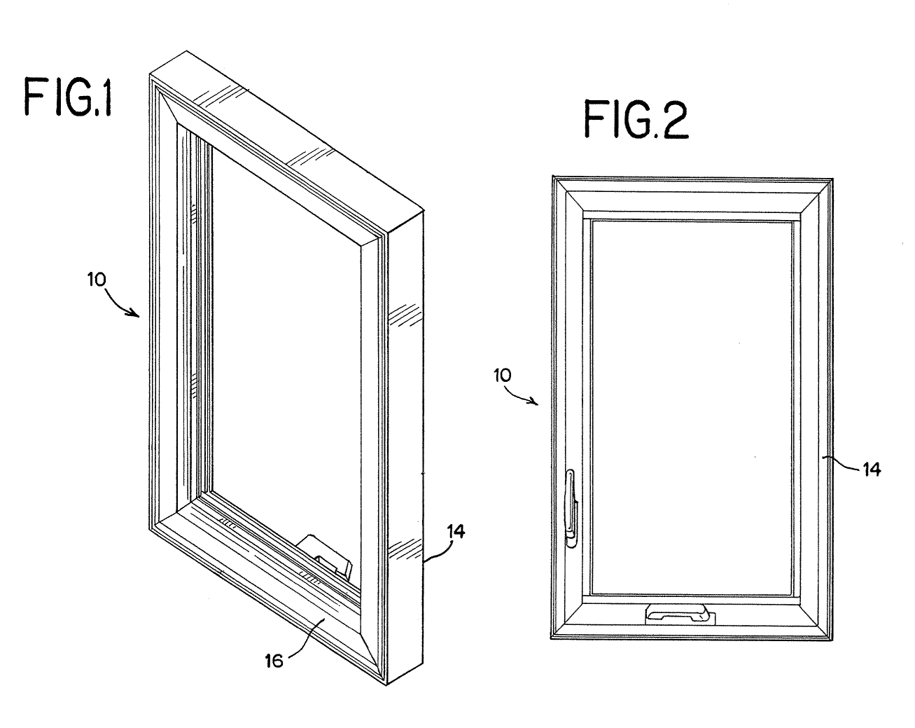

As can be appreciated from FIGS. 3 and 6, as a user turns the handle 34 to close the sash window 16, the second member 54 approaches the first member 52. Due to the cooperative structures described above, the members 52,54 are in a cooperative and confronting relation as shown in FIG. 6. It is also understood that in the closed position, the members 52,54 are concealed and cannot be seen from a front or rear view of the casement window assembly (FIGS. 1 and 2). FIG. 6 is a schematic partial view showing the sash window 16 in a closed position relative to the window frame 14 and showing a top view of the members 52,54. In this closed position, the cooperative structures 56 are spaced apart in confronting relation. The first tab 70 extends to the second cavity 86 and the second tab 84 extends to the first cavity 70. Tab length or member adjustment can be made wherein the tabs 70,84 extend further into the cavities 72,86.

If the sash window 16 is subjected to high stresses such as from high winds in a storm including a hurricane, the sash window 16 will try to bow with respect to the window frame 14. This may move the snubber members 52,54. In particular, the tabs 70,84 and legs 66,80 may move in response to the applied stresses. For example, the first tab 70 may move towards and engage the second leg 80 (arrow A) and the second tab 84 may move towards and engage the first leg 66 (arrow B). The tabs 70,84 are generally normal to the respective legs 66,80. The tabs 70,84 and legs 66,80 cooperate to resist undue bowing of the sash window 16 with respect to the window frame 14. Forces from different directions can be withstood to minimize the chances that the sash window 14 will roll and bow too much causing failure of the window assembly 10 or adversely affecting the rating of the window. In particular, the snubber members 52,54 resist rolling or twisting of the vertical rail 25 due to stresses and/or applied negative pressures. The tabs further enhance this resistance. The snubber mechanism 50 thus reduces the chances of failure or rating effect. Obviously, the snubber mechanism has certain structural limitations and cannot be considered a complete safety guard to such unforeseen forces of an extreme magnitude. As can be appreciated from FIGS. 3 and 6, when a user wishes to open the sash window 16, the second member 54 can easily separate from the first member 52 wherein the members 52,54 are significantly separated and not in confronting relation. The spaced configuration allows ease of installation without the need for constant adjustments while still allowing interaction between the members 52,54 in the closed window position to minimize undue bowing of the sash window 16 relative to the frame 14. It is understood that the first member 52 and second member 54 can also incorporate further structures or configuration. The members can be configured to have less spacing between the tabs and legs. The tabs can also be configured to abut the legs and provide a normal force against the legs. The members 52,54 can also incorporate projection/receiver structures as described with the embodiments below.

FIG. 7 shows another partial view of a casement window assembly 10′ showing the snubber members 52,54 in a confronting and spaced relation when the sash window 16 is closed relative to the window frame 14. It is further understood that the casement window assembly 10′ could utilize an additional snubber mechanism 50 wherein another pair of snubber members 52′,54′ are mounted and are in a confronting and spaced relation when the sash window 16 is closed relative to the window frame 14.

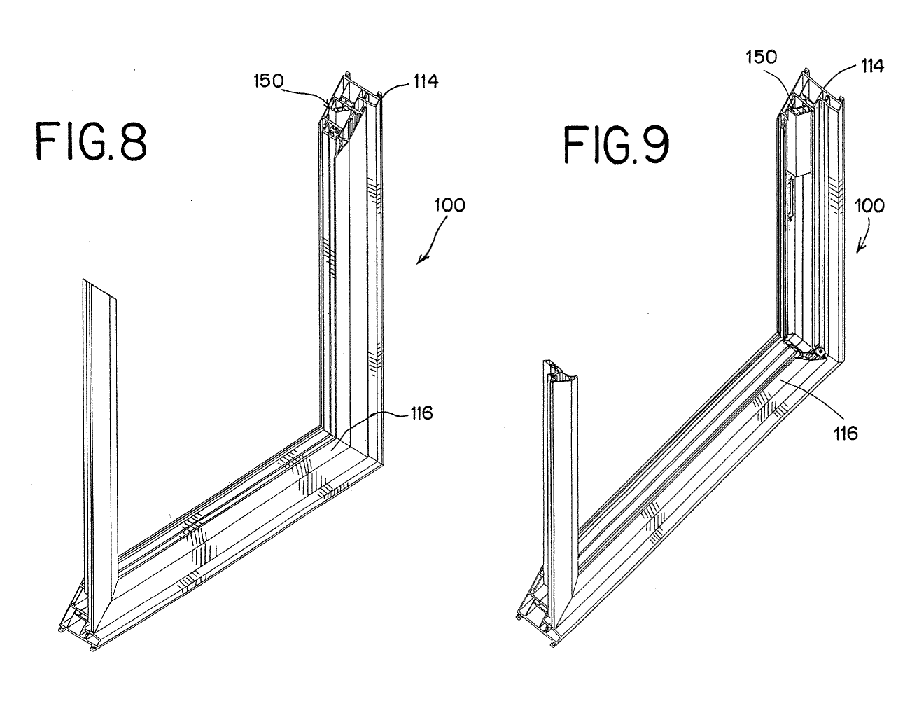

FIGS. 8-12 show a casement window assembly utilizing another embodiment of a snubber mechanism of the present invention, designated with the reference numeral 150. Components similar to the embodiment of FIGS. 1-7 will be designated with similar reference numerals in a 100 series. The snubber mechanism 150 is partially shown on the casement window assembly 10. In FIG. 9, a portion of the casement window assembly structure has been removed to more fully show this embodiment of the snubber mechanism 150. The snubber mechanism 150 has a longer length than the snubber mechanism 50 of FIGS. 1-7. As shown in FIGS. 8-10, the snubber mechanism 150 generally includes a first snubber member 152 and a second snubber member 154. The snubber members 152,154 have cooperative structure 156 that cooperate to prevent undue bowing of the sash window 16 with respect to the window frame 14 as will be described in greater detail below.

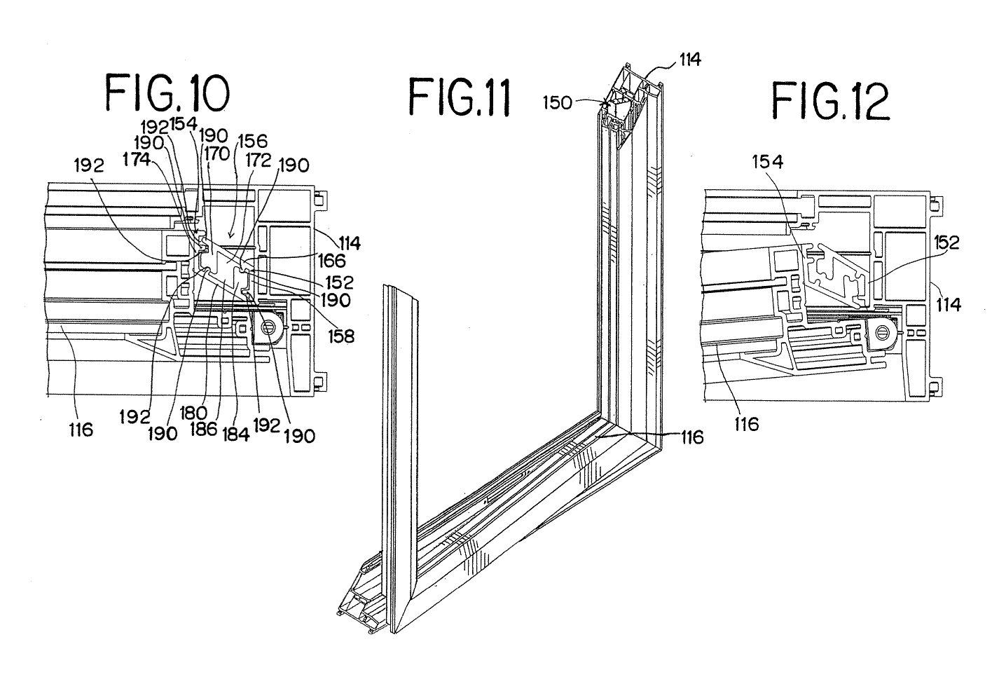

The snubber members 152,154 have similar structure to the snubber members 52,54 shown in FIGS. 1-7. As further shown FIG. 10, the first snubber member 152 has a first base 158, a first leg 166 and a first tab 170 that cooperatively form a first cavity 172. Similarly, the second snubber member 154 has a second base 174, a second leg 180, and a second tab 184 that cooperatively form a second cavity 186. The cooperative structure 156 includes the members 152,154 being in confronting and spaced relation when the sash window 116 is closed relative to the window frame 114. The first tab 170 extends into the second cavity 186 and the second tab 184 extends into the first cavity 172.

The cooperative structure 156 of the snubber members 152,154 includes additional structures. As shown in FIG. 10, the snubber members 152,154 include a plurality of projections 190 and receivers 192. In one exemplary embodiment, four pairs of projections 190 and receivers 192 are included. In particular, the first base 158 includes a projection 190 and the first leg 166 includes two projections 190. The first tab 170 has a receiver 192. The second base 174 has a receiver 192 and the second leg 180 has a projection 190 and a receiver 192. Finally, the second tab 184 has a receiver 192. As can be appreciated from FIG. 10, the projections 190 cooperate with the receivers 192. Thus, a respective receiver 192 receives a respective projection 190 when the sash window 116 is in the closed position. The projections 190 and receivers 192 confront one another and may be in spaced or abutting relation when the sash window 116 is in a closed position. The projections 190 and receivers 192 can have rounded surfaces if desired. The projections 190 and receivers 192 can be on various locations on the members 152,154 including distal ends of the tabs 170,184.

As shown, the first snubber member 152 is connected to the window frame 114 while the second snubber member 54 is connected to the sash window 116. These connections can be done by any method known in the art included screwed fasteners as described above. In a preferred embodiment, the snubber members 152,154 are mounted on the vertical rail and jamb of the casement window assembly 100. Other locations are possible.

As shown in FIG. 10, the first tab 170 extends into the second cavity 186 and the second tab 184 extends into the first cavity 172. Also when the sash window 16 is in the closed position, the projections 190 are received by the receivers 192. If the sash window 16 is subjected to high stresses such as from high winds in a storm including a hurricane, the sash window 16 will try to bow with respect to the window frame 14. This may move the snubber members 152,154 and the projections 190 and receivers 192 on the snubber members 52,54. These cooperative structures cooperate to resist undue bowing of the sash window 116 with respect to the window frame 114. In addition, the cooperative structures are engaging at various locations. With the four pairs of projections 190 and receivers 192, forces from different directions can be withstood. FIGS. 11 and 12 show the casement window assembly 10 in an open position wherein the snubber members 152,154 can separate each other wherein the projections 58 are spaced further away from the receivers 60. The structure of the members 152,154 permits this rotational movement when the sash window 116 moves to an open position. When the sash window 116 is closed again, it is understood that the snubber members 152,154 return to the confronting relation as shown in FIG. 10.

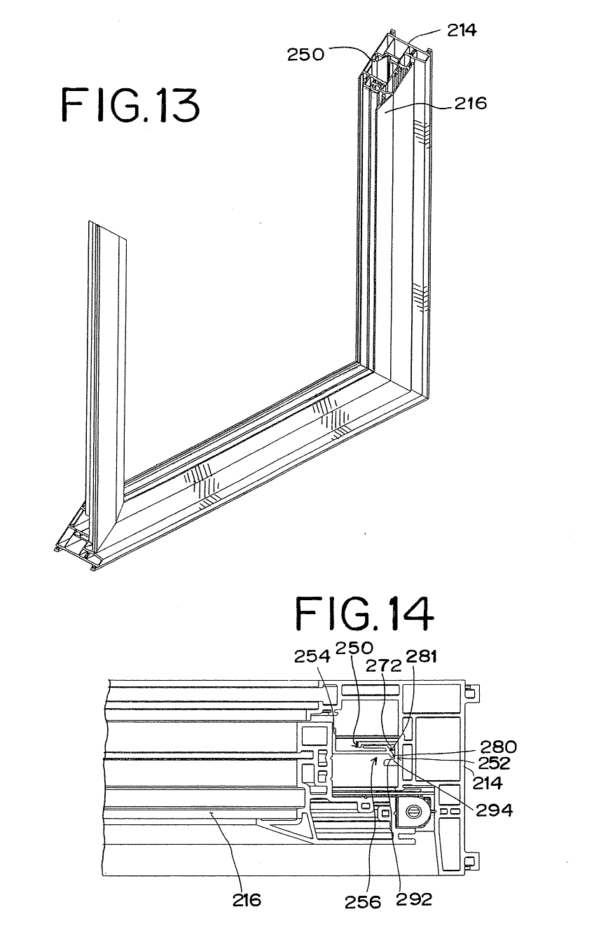

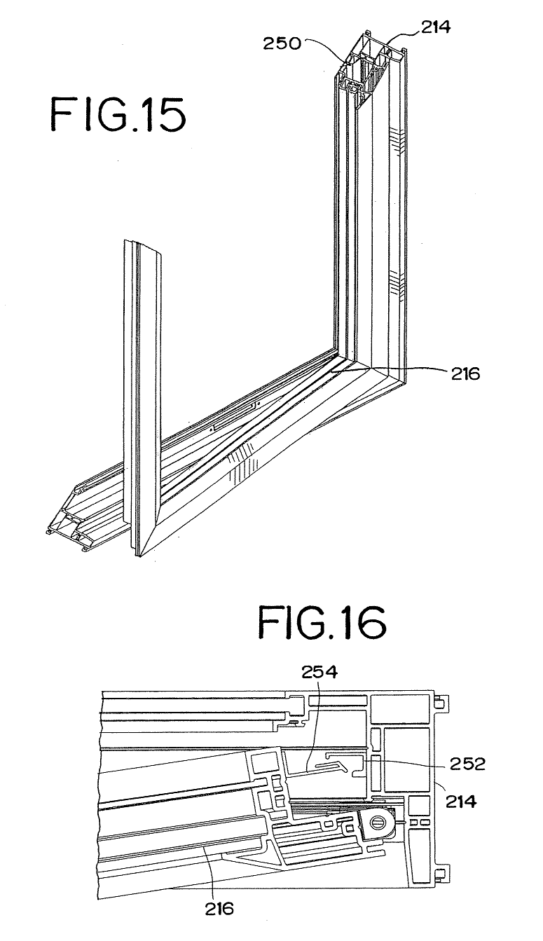

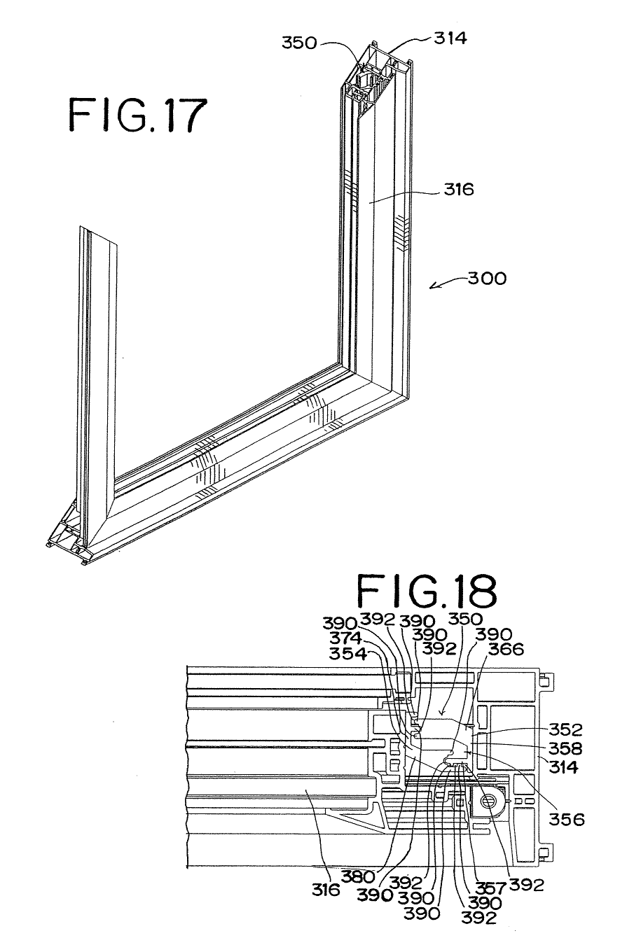

FIGS. 13-16 show an alternative embodiment of the snubber mechanism of the present invention, generally designated with the reference numeral 250. Similar structures to previous embodiments will be designated with similar reference numerals in the 200 series. The snubber mechanism 250 has a first snubber member 252 and a second snubber member 254. The members 252,254 have cooperative structure 256 to resist undue bowing. The first snubber member 252 on the window frame 214 has a base, leg and tab to form a first cavity 272. The second snubber member 254 has a leg assembly 281 that extends into the first cavity 272. The leg assembly 281 includes a plurality of interconnected legs as well as a projection 290 that extends towards a corner 294 of the first member 252 that forms a receiver 292. These cooperative structures 256 have similar functions to the cooperative structures described above to resist undue bowing and over rotation of the sash window 16 when subjected to stresses. FIGS. 15 and 16 show the casement window assembly 10 in an open position wherein the members 152,154 can rotate away from one another from their confronting relation. It is understood that the casement window assembly 200 can be rotated to the closed position wherein the members 252,254 can be in a confronting relation.

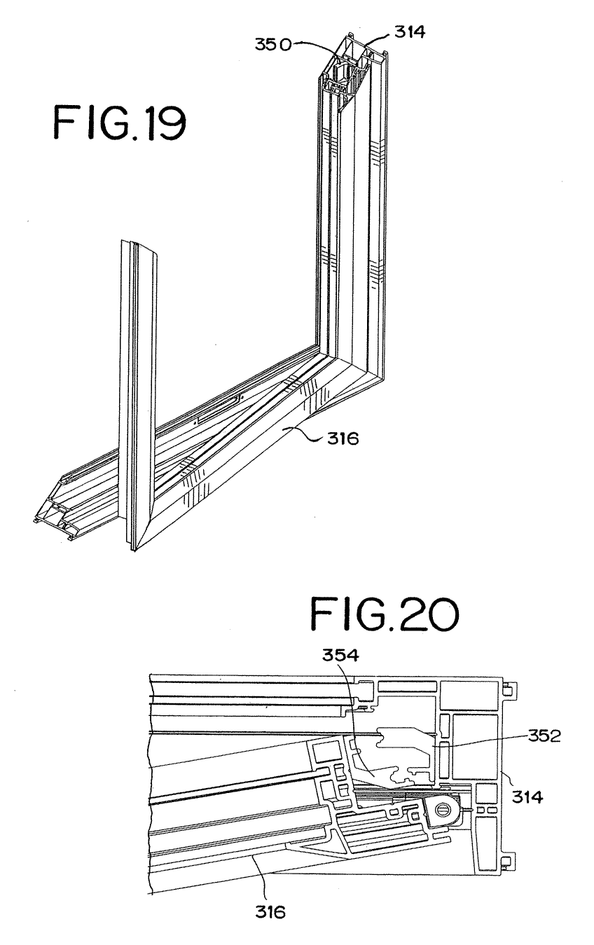

FIGS. 17-20 show an alternative embodiment of the snubber mechanism of the present invention designated with the reference numeral 350. Similar structures to previous embodiments will be designated with similar reference numerals in the 300 series. The snubber mechanism 350 has a first snubber member 352 on the window frame 314 and a second snubber member 354 on the sash window 316. The members 352,354 have cooperative structure 356 in the form of cooperating legs and projections 390 and receivers 392. In particular, the first member 352 has a first leg 366 and a second leg 357 that extend from a base 358 of the first member 352. The first leg 366 has a more robust dimension and projects towards a base 374 of the second member 352. A distal end of the first leg 366 has a pair of projections 390 that define a receiver 392 therebetween. The receiver 392 receives a projection 390 on the base 374 of the second member 354. A distal end of the leg 380 on the second member 354 also has a more robust dimension and projects towards the base 358 on the first member 352. The distal end of the leg 380 also has a pair of projections 390 defining a receiver 392 therebetween. The receiver 392 on the distal end receives the second leg 357. The second leg 357 also has a projection 390 that, with the base 358, forms a receiver 392 to receive a projection 390. The cooperative structures 356 have similar functions to the cooperative structures described above to resist undue bowing and over rotation of the sash window 316. FIGS. 19 and 20 show the casement window assembly 10 in an open position where the members 352,354 can rotate away from one another.

Thus, it can be understood that the snubber members and cooperative structures provide an enhanced structure for the casement window assembly wherein bowing of the sash window 16 is minimized when subjected to high stresses such as from wind loads. The snubber mechanism also improves the negative pressure rating of the window assembly. The cooperative structures provide enhanced strength and durability over previous snubber designs. In addition, when the sash window is in a closed position, the snubber mechanism is concealed from view but still operative. It is further understood that the snubber mechanism can be utilized in any type of window assembly or other closures including door assemblies.

While the specific embodiments have been illustrated and described, numerous modifications come to mind without significantly departing from the spirit of the invention, and the scope of protection is only limited by the scope of the accompanying Claims.

What is claimed is:

1. A snubber mechanism for a casement window assembly having a hinged window pivotally mounted within a window frame, the snubber mechanism comprising:
a first member adapted to be mounted on the window frame;
a second member adapted to be mounted on the sash window; and
cooperative structures on the members wherein when the sash window is in a closed position with respect to the window frame, the cooperative structures are spaced apart in confronting relation and are adapted to minimize undue bowing of the sash window with respect to the window frame.

2. The snubber mechanism of claim 1 wherein the first member has a first base adapted to be mounted on the window frame, the first member further having a first leg extending from the first base, the first leg having a first tab extending generally transverse therefrom.

3. The snubber mechanism of claim 2 wherein the first base, first leg and the first tab cooperatively form a first cavity.

4. The snubber mechanism of claim 1 wherein the second member has a second base adapted to be mounted on the sash window, the second member further having a second leg extending from the second base, the second leg having a second tab extending generally transverse therefrom.

5. The snubber mechanism of claim 4 wherein the second base, second leg and the second tab cooperatively form a second cavity.

6. The snubber mechanism of claim 1 wherein the first member has a first base adapted to be mounted on the window frame, the first member further having a first leg extending from the first base, the first leg having a first tab extending generally transverse therefrom, wherein the first base, first leg and the first tab cooperatively form a first cavity, and wherein the second member has a second base adapted to be mounted on the sash window, the second member further having a second leg extending from the second base, the second leg having a second tab extending generally transverse therefrom, wherein the second base, second leg and the second tab cooperatively form a second cavity.

7. The snubber mechanism of claim 6 wherein when the sash window is in the closed position, the first tab extends to the second cavity and the second tab extends to the first cavity.

8. The snubber mechanism of claim 7 wherein upon bowing of the sash window frame due to stresses applied to the window assembly, the first tab engages the second leg to prevent undue bowing of the sash window.

9. The snubber mechanism of claim 7 wherein upon bowing of the sash window frame due to stresses applied to the window assembly, the second tab engages the first leg to prevent undue bowing of the sash window.

10. The snubber mechanism of claim 1 wherein the first member is identical to the second member.

11. The snubber mechanism of claim 1 wherein the first member and the second member are concealed with the sash window is in the closed position.

12. The snubber mechanism of claim 1 wherein the cooperative structures further comprise one of the first member and the second member having a projection and the other of the first member and the second member having a receiver, wherein when the sash window is in a closed position with respect to the window frame, the receiver receives the projection.

13. The snubber mechanism of claim 12 further comprising a plurality of projections and receivers, a respective receiver receiving a projection.

14. The snubber mechanism of claim 1 wherein the first member has a first base adapted to be mounted on the window frame, the first member further having a first leg extending from the first base, the first leg having a first tab extending from the first leg, wherein the first base, first leg and the first tab cooperatively form a first cavity, and wherein the second member has a second base adapted to be mounted on the sash window, the second member further having a second leg extending from the second base, the second leg having a second tab extending from the second leg, wherein the second base, second leg and the second tab cooperatively form a second cavity.

15. The snubber mechanism of claim 14 wherein when the sash window is in the closed position, the first tab extends into the second cavity and the second tab extends into the first cavity.

16. The snubber mechanism of claim 15 wherein the first leg has a first projection and the first tab has a first receiver, and wherein the second leg has a second projection and the second tab has a second receiver, wherein when the sash window is in the closed position, the first projection is received in the second receiver and the second projection is received in the first receiver.

17. A snubber mechanism for a casement window assembly having a hinged window pivotally mounted within a window frame, the snubber mechanism comprising:
a first member having a first base adapted to be mounted on the window frame, the first member having a first leg extending from the first base, the first member further having a first tab extending generally transverse from a distal end of the first leg;
a second member having a second base adapted to be mounted on the sash window, the second member having a second leg extending from the second base, the second member further having a second tab extending generally transverse from a distal end of the second leg,
wherein when the sash window is in a closed position with respect to the window frame, the first member confronts and is spaced from the second member and wherein the first tab confronts the second flange and the second tab confronts the first flange wherein the members are adapted to minimize undue bowing of the sash window with respect to the window frame.

18. A casement window assembly comprising:
a window frame;
a hinged window pivotally supported within the window frame, the window moveable between an open position and closed position;
a snubber mechanism comprising:
a first member having a first base mounted on the window frame, the first member further having a first leg extending from the first base, the first leg having a first tab extending generally transverse therefrom, wherein the first base, first leg and the first tab cooperatively form a first cavity;
a second member having a second base mounted on the sash window, the second member further having a second leg extending from the second base, the second leg having a second tab extending generally transverse therefrom, wherein the second base, second leg and the second tab cooperatively form a second cavity,
wherein when the sash window is the closed position, the first tab extends to the second cavity and the second tab extends to the first cavity.

19. The casement window assembly of claim 18, wherein the window frame has a vertical jamb and the window frame has a vertical rail wherein the first member is mounted proximate a midpoint of the vertical jamb and the second member is mounted proximate a midpoint of the vertical rail.

20. The casement window assembly of claim 18, further comprising a second snubber mechanism mounted on the window frame and sash window and spaced from the snubber mechanism.

21. The casement window assembly of claim 18 wherein the snubber mechanism comprises a plurality of snubber mechanisms mounted along the vertical jamb and vertical rail.
